(19) United States
(12) Patent Application Publication
(10) Pub. No.: US 2009/0237323 A1
(43) Pub. Date: Sep. 24, 2009

(54) Apparatus and method for reducing electromagnetic waves

(75) Inventors: Sang il Kwak, Daejeon (KR); Jong Hwa Kwon, Daejeon (KR); Dong-Uk Sim, Daejeon (KR); Hyung-Do Choi, Daejeon (KR); Chang-Joo Kim, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute

(21) Appl. No.: 12/319,776

(22) Filed: Jan. 12, 2009

(30) Foreign Application Priority Data
Mar. 19, 2008 (KR) 10-2008-0025389

(51) Int. Cl. H01Q 15/00

(52) U.S. Cl. 343/909

(57) ABSTRACT

An apparatus for reducing electromagnetic waves, includes an electromagnetic bandgap for reducing a surface current induced by electromagnetic waves that are emitted from a radiator; and an absorber for reducing a surface current around the electromagnetic bandgap and for diminishing diffracted waves radiated from an end of a terminal.

### CROSS-REFERENCE TO RELATED APPLICATION(S)

The present invention claims priority of Korean Patent Application No. 10-2008-0025389, filed on Mar. 19, 2008, which is incorporated herein by reference.

### FIELD OF THE INVENTION

The present invention relates to an apparatus and method for reducing electromagnetic waves, and more specifically, to an apparatus and method capable of reducing the influence of electromagnetic waves by using an electromagnetic bandgap (EBG) and an electromagnetic absorber.

This work was supported by the IT R&D program of MIC/IITA [2007-F-043-02, Study on Diagnosis and Protection Technology based on EM].

### BACKGROUND OF THE INVENTION

With the recent rapid advances in IT and the ever increasing desire for communications of mankind, radio communication equipments such as mobile terminals have been necessities of the moderners. As more people use such a mobile terminal, however, the influence of electromagnetic waves from the terminal upon the human body has become another important issue. There was no definite explanation about the relationship between electromagnetic waves within the frequency band of a mobile phone and their effects on the human body, but it has been reported that incident electromagnetic waves might affect all kinds of diseases that include leukemia, brain tumor, headache, defective eyesight, brainwave disorders when accumulated in the body, hypofunction of the male genital organs, etc. Therefore, many studies are now under progress to block electromagnetic waves to prevent any bad influence of them upon the human body.

One of conventional approaches for reducing the influence of electromagnetic waves was to use an electromagnetic bandgap (EBG) and the other was to use an electromagnetic absorber.

The EBG technique involves manipulating the formation of an artificial metal pattern over a dielectric substrate on a regular basis to change inherent electromagnetic properties of the metal itself. This is also called an artificial magnetic conductor (AMC) because magnetic conductor properties that do not really exist in nature are created intentionally on an ordinary metal conductor, or called a high impedance surface (HIS) because it has a high impedance surface. Because of high impedance on the surface, a bandgap is produced in a particular band, and the produced bandgap reduces a surface current to suppress the generation of surface waves. However, some EBGs have a problem that the number of unit cells with a metal pattern is not sufficient to completely reduce the surface current, or sometimes a specific absorption rate (SAR) is greater than the bandgap.

Meanwhile, the electromagnetic absorber technique is an ongoing study of the effects of diminished electromagnetic radiation in relation to different dielectric constants in diverse combinations of ferrite and other compositions and depending on absorber attachment positions. Particularly, this technique has widely been adapted to some fields like a shielding material of anechoic chamber and a scheme for reducing electromagnetic waves from mobile terminals. However, one problem of such technique using an electromagnetic absorber is that the absorber impairs the performance of a radiator or an emitter.

### SUMMARY OF THE INVENTION

In view of the above, the present invention provides an apparatus for reducing electromagnetic waves to be used in hand-held or proximate IT devices, e.g., mobile terminals, in which the apparatus uses an EBG and an electromagnetic absorber to reduce a surface current and surface wave generated by electromagnetic waves from a radiator, so that it also reduces electromagnetic waves which exert adverse effects upon the human body while maintaining radiation performance of the radiator.

In accordance with a first aspect of the present invention, there is provided an apparatus for reducing electromagnetic waves, including: an electromagnetic bandgap for reducing a surface current induced by electromagnetic waves that are emitted from a radiator; and an absorber for reducing a surface current around the electromagnetic bandgap and for diminishing diffracted waves radiated from an end of a terminal.

Preferably, a specific absorption rate and performance of the radiator are regulated by changing a length of the absorber.

Preferably, the electromagnetic bandgap includes a ground layer made of a conductor; a dielectric layer formed on the ground layer; and a plurality of metal unit cells periodically arranged on the dielectric layer.

Preferably, the apparatus for reducing electromagnetic waves further includes via holes for connecting the ground layer and the plurality of metal unit cells.

Preferably, the gap between the unit cells and a size of the metal unit cell are controlled such that a surface current is reduced at a desired frequency band.

Preferably, the apparatus is applied to body worn devices including mobile terminals to protect a human body from electromagnetic waves.

In accordance with a second aspect of the present invention, there is provided a method for reducing electromagnetic waves, including: forming an electromagnetic bandgap for reducing a surface current induced by electromagnetic waves that are emitted from a radiator; and forming an absorber for reducing a surface current around the electromagnetic bandgap and for diminishing diffracted waves radiated from an end of a terminal.

In accordance with the present invention, an SAR in a human body is low as compared to other cases where only an EBG is used, and radiation performance of the radiator is retained as compared to other cases where only an absorber is used. This is achieved by employing both an EBG for reducing a surface current induced by electromagnetic waves from a radiator and an absorber for reducing a surface current around the EBG and for diminishing diffracted waves radiating from the end of the terminal.

### BRIEF DESCRIPTION OF THE DRAWINGS

The patent or application file contains at least one drawing (or color photograph) executed in color. Copies of this patent or patent application publication with color drawing(s) will be provided by the Office upon request and payment of the necessary fee. The objects and features of the present invention will become apparent from the following description of embodiments, given in conjunction with the accompanying drawings, in which:

FIG. 1 shows a plane view of an apparatus for reducing electromagnetic waves using an EBG and an absorber, in accordance with an embodiment of the present invention;

FIG. 2 provides a front view of an apparatus for reducing electromagnetic waves using an EBG and an absorber, in accordance with the embodiment of present invention;

FIG. 3 illustrates an example where an apparatus for reducing electromagnetic waves in accordance with the embodiment of the present invention is applied to an interior of a mobile terminal with embedded antenna;

FIG. 4 presents a first modified example where an apparatus for reducing electromagnetic waves in accordance with the embodiment the present invention is applied to an exterior of a mobile terminal with embedded antenna;

FIG. 5 provides a second modified example where an apparatus for reducing electromagnetic waves in accordance with the embodiment of the present invention is installed in both interior and exterior of a mobile terminal with embedded antenna;

FIG. 6 illustrates a third modified example where an apparatus for reducing electromagnetic waves in accordance with the embodiment of the present invention is applied to a mobile terminal with an external antenna;

FIG. 7 depicts a comparison between an electromagnetic radiation pattern from a planar inverted-F antenna (PIFA) and an electromagnetic radiation pattern from a PIFA provided with an apparatus for reducing electromagnetic waves in accordance with the embodiment the present invention;

FIGS. 8A to 8C show the simulation result of SAR distribution in a human head for a mobile terminal with embedded antenna, the simulation result of SAR distribution in a human head for a mobile terminal with embedded antenna using only an EBG, and the simulation result of SAR distribution in a human head for a mobile terminal with embedded antenna using both an EBG and an absorber, respectively; and

FIG. 9 describes a flowchart illustrating a method for reducing electromagnetic waves in accordance with the embodiment of the present invention.

### DETAILED DESCRIPTION OF THE EMBODIMENT

Hereinafter, embodiments of the present invention will be described in detail with reference to the accompanying drawings which form a part hereof.

FIG. 1 shows a plane view of an apparatus for reducing electromagnetic waves using an EBG and an electromagnetic absorber, in accordance with the embodiment of the present invention. Referring to FIG. 1, the apparatus 100 for reducing electromagnetic waves includes a dielectric substrate 110, plural metal unit cells 120 and an electromagnetic absorber 130.

The dielectric substrate 110 and the plural metal unit cells 120 function as an EBG for reducing a surface current that is induced by electromagnetic waves emitted from a radiator.

The electromagnetic absorber 130 reduces the surface current around the EBG constituted by the dielectric substrate 110 and the plural metal unit cells 120, and diminishes diffracted waves radiating from the end of a terminal.

Via holes 140 may be selectively provided when necessary, and are configured to determine an operating frequency band of the EBG as a parameter relevant to inductance generated in the unit cells.

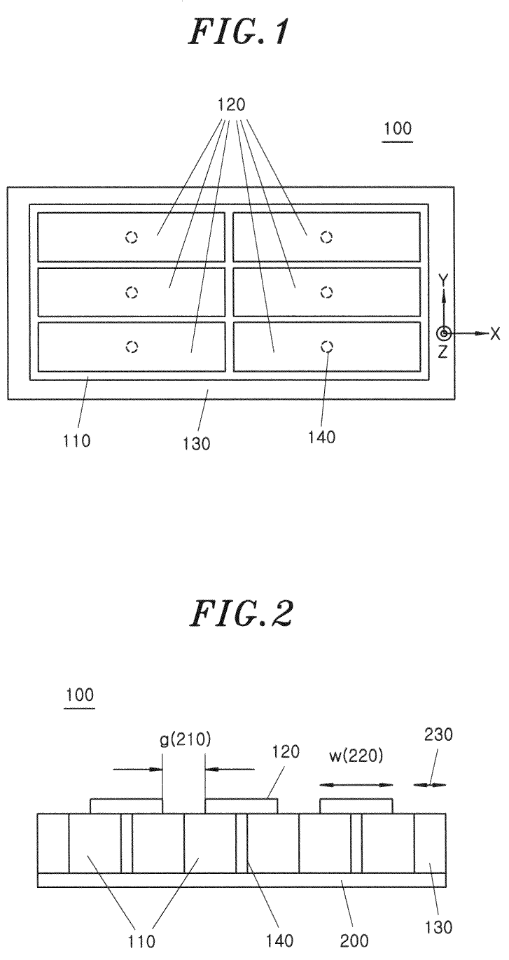

FIG. 2 presents a front view of an apparatus for reducing electromagnetic waves using an EBG and an electromagnetic absorber, in accordance with an embodiment of the present invention. Referring to FIG. 2, the apparatus 100 for reducing electromagnetic waves can be fabricated in a laminated form where a dielectric layer 110 is formed on a ground layer 200 made of a conductor, plural metal unit cells 120 are periodically arranged on the dielectric layer 110, and an electromagnetic wave absorber material 130 such as ferrite is applied in surround areas. At this time, it is possible to design the EBG with a desired frequency band by controlling a gap 210 between the metal unit cells and a patch size 220, and to regulate an absorption rate and performance of a radiator by changing a length 230 of the absorber.

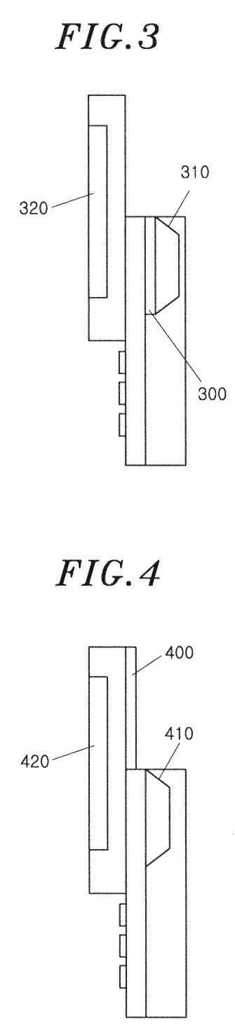

FIG. 3 illustrates an example where an apparatus 300 for reducing electromagnetic waves in accordance with the embodiment of the present invention is applied to an interior of a mobile terminal with embedded antenna. Referring to FIG. 3, the apparatus 300 for reducing electromagnetic waves in accordance with the embodiment of the present invention is inserted into a region between an antenna 310 which is an electromagnetic radiator and a display 320 mainly because the display 320 makes a direct contact with the face of a user.

FIG. 4 illustrates a first modified example where an apparatus 400 for reducing electromagnetic waves in accordance with the embodiment of the present invention is applied to an exterior of a mobile terminal with embedded antenna. Referring to FIG. 4, the apparatus 400 for reducing electromagnetic waves in accordance with the embodiment of the present invention is attached to the rear side of a display 420 in a region between an antenna 410 which is an electromagnetic radiator and the display 420 mainly because the display 420 makes a direct contact with the face of the user.

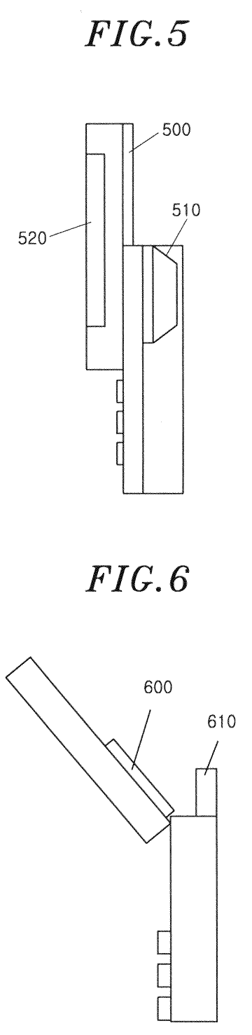

FIG. 5 illustrates a second modified example where an apparatus 500 for reducing electromagnetic waves in accordance with the embodiment of the present invention is installed in both interior and exterior of a mobile terminal with embedded antenna. Referring to FIG. 5, the apparatus 500 for reducing electromagnetic waves in accordance with the embodiment of the present invention is attached to both the rear side of a display 520 and in the back of an antenna 510 in regions between the antenna 510 which is an electromagnetic radiator and the display 520 mainly because the display 520 makes a direct contact with the face of a user.

FIG. 6 illustrates a third modified example where an apparatus 600 for reducing electromagnetic waves in accordance with the embodiment of the present invention is applied to a mobile terminal with an external antenna. The apparatus 600 for reducing electromagnetic waves in accordance with the embodiment of the present invention is attached to a region between the front side of a terminal and an antenna 610 which is an electromagnetic radiator.

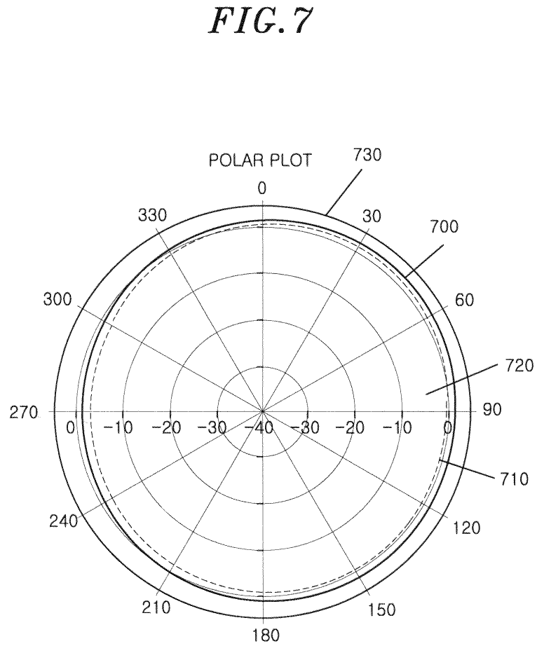

FIG. 7 graphically plots electromagnetic shielding effects with or without an apparatus for reducing electromagnetic waves in accordance with the embodiment of the present invention. Especially, FIG. 7 shows a polar coordinate system, in which numbers on X-axis (or the radial coordinate) 720 indicate the intensity of electromagnetic waves, and numbers on the angular coordinate 730 indicate electromagnetic radiation angle. A solid line 700 denotes the intensity of an electromagnetic wave by angle, the electromagnetic wave being emitted from a planar inverted-F antenna (PIFA) without an apparatus for reducing electromagnetic waves. Meanwhile, a dotted line 710 denotes the intensity of an electromagnetic wave by angle, the electromagnetic wave being emitted from a PIFA with an apparatus for reducing electromagnetic waves. FIG. 7 was obtained by simulating the application of the apparatus for reducing electromagnetic waves of the present invention to the mobile terminal as shown in FIG. 3 at one of commercial mobile communication frequency bands, 1.88 GHz. Comparing between antenna radiation patterns before and after the application of the present invention apparatus, that is, comparing the solid line 700 with the dotted line 710, it can be seen that the radiation intensity was lowered in a direction between 180 degrees and 360 degrees towards a human body.

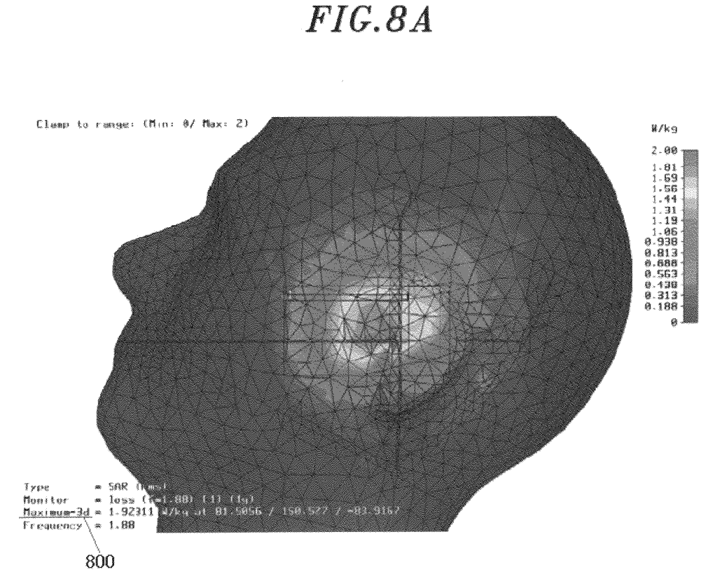

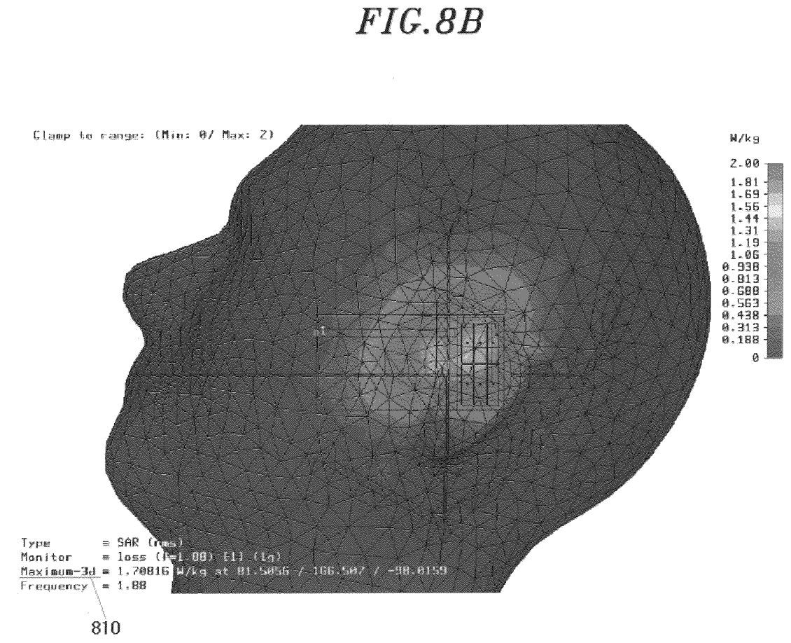

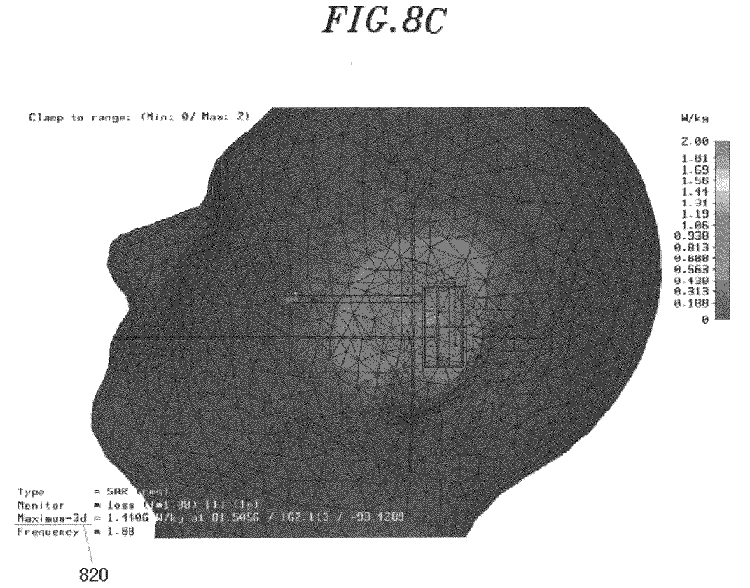

FIGS. 8A to 8C provide numbers and pictures showing the influence of electromagnetic waves on a human body, namely, the simulation results of specific absorption rate (SAR) at one of commercial mobile communication frequency bands, 1.88 GHz, when the apparatus for reducing electromagnetic waves in accordance with the present invention is applied to the mobile terminal with embedded antenna in FIG. 3. Referring to FIGS. 8A to 8C, 1 g average SAR value 800 was 1.923 when only a mobile terminal was used for communication, and 1 g average SAR value 810 was 1.7081 when a mobile terminal with an EBG only was used for communication, and 1 g average SAR value 820 was substantially reduced to 1.410 when a mobile terminal with the apparatus for reducing electromagnetic waves of the present invention (i.e., the combination use of an EBG and an absorber) was used for communication. Therefore, the present invention is very advantageous for protecting the human body by reducing electromagnetic waves.

The apparatus for reducing electromagnetic waves in accordance with the embodiment of the present invention becomes useful especially when the use of an EBG only is not sufficient to block propagation of a surface current in a defined space such as portable equipment. That is, using the electromagnetic absorber in the apparatus blocks the surface current and further reduces electromagnetic waves even in a space where the structure of an EBG does not have enough unit cells, thereby enhancing isolation between RF devices.

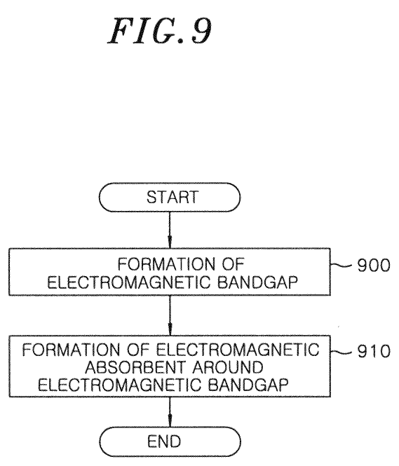

FIG. 9 describes a flowchart illustrating a method for reducing electromagnetic waves in accordance with the embodiment of the present invention. Referring to FIGS. 1 and 9, in step 900, EBGs 110 and 120 are first formed to reduce a surface current that is induced by electromagnetic waves generated from a radiator.

Next, in step 910, an electromagnetic absorber 130 is formed to reduce a surface current around the EBGs 110 constituted by the dielectric substrate 110 and the plural metal unit cells 120 and to diminish diffracted current radiating from the end of a terminal. Here, an absorption rate and performance of the radiator can also be regulated by changing a length of the absorber 130.

While the invention has been shown and described with respect to the embodiment, it will be understood by those skilled in the art that various changes and modifications may be made without departing from the scope of the invention as defined in the following claims.

What is claimed is:

1. An apparatus for reducing electromagnetic waves, comprising:
an electromagnetic bandgap for reducing a surface current induced by electromagnetic waves that are emitted from a radiator; and
an absorber for reducing a surface current around the electromagnetic bandgap and for diminishing diffracted waves radiated from an end of a terminal.

2. The apparatus of claim 1, wherein a specific absorption rate and performance of the radiator are regulated by changing a length of the absorber.

3. The apparatus of claim 1, wherein the electromagnetic bandgap includes:
a ground layer made of a conductor;
a dielectric layer formed on the ground layer; and
a plurality of metal unit cells periodically arranged on the dielectric layer.

4. The apparatus of claim 3, further comprising:
via holes for connecting the ground layer and the plurality of metal unit cells.

5. The apparatus of claim 3, wherein the gap between the unit cells and a size of the metal unit cell are controlled such that a surface current is reduced at a desired frequency band.

6. The apparatus of claim 1, wherein the apparatus is applied to body worn devices including mobile terminals to protect a human body from electromagnetic waves.

7. A method for reducing electromagnetic waves, comprising:
forming an electromagnetic bandgap for reducing a surface current induced by electromagnetic waves that are emitted from a radiator; and
forming an absorber for reducing a surface current around the electromagnetic bandgap and for diminishing diffracted waves radiated from an end of a terminal.

8. The method of claim 7, wherein a specific absorption rate and performance of the radiator are regulated by changing a length of the absorber.
